(19) United States
(12) Patent Application Publication
(10) Pub. No.: US 2025/0323310 A1
(43) Pub. Date: Oct. 16, 2025

(54) SODIUM-ION BATTERY

(71) Applicant: ZHUHAI COSMX BATTERY CO., LTD., Zhuhai (CN)

(72) Inventors: Hai WANG, Zhuhai (CN); Huawen HUANG, Zhuhai (CN); Hui ZHU, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 19/249,578

(22) Filed: Jun. 25, 2025

Related U.S. Application Data
(63) Continuation of application No. PCT/CN2024/078537, filed on Feb. 26, 2024.

(30) Foreign Application Priority Data
Mar. 23, 2023 (CN) 202310292217.3

(51) Int. Cl. H01M 10/054; H01M 4/02; H01M 4/131; H01M 4/505; H01M 4/525; H01M 10/0567; H01M 10/0568

(52) U.S. Cl. CPC H01M 10/054; H01M 4/131; H01M 4/505; H01M 4/525; H01M 10/0567; H01M 10/0568; H01M 2004/021; H01M 2004/027; H01M 2004/028

(57) ABSTRACT

Disclosed is a sodium-ion battery. By doping the positive electrode active substance with metallic M element and adding vinylene carbonate (VC) to the electrolyte solution, the metallic M element can effectively promote VC to form a film preferentially on the positive electrode. By regulating a mass content of ethylene carbonate in a total mass of the electrolyte solution, a mass content of vinylene carbonate in the total mass of the electrolyte solution, and a molar amount of the M element per mole of the positive electrode active substance, so that they satisfy 0≤w₁≤30% and 0≤w₁/(w₂+d)≤5, the stability of the sodium-ion battery can be greatly improved, and the gas generation phenomenon can be reduced.

### CROSS-REFERENCE TO RELATED APPLICATIONS

The present disclosure is a continuation of International Application No. PCT/CN2024/078537, filed on Feb. 26, 2024, which claims priority to Chinese Patent Application No. 202310292217.3, filed on Mar. 23, 2023. All of the aforementioned patent disclosures are hereby incorporated by reference in their entireties.

### TECHNICAL FIELD

The present disclosure relates to a field of sodium-ion battery technology, and specifically relates to a sodium-ion battery.

### BACKGROUND

Sodium-ion battery has broad application prospects due to its comprehensive advantages such as good safety, low cost, rich resource, and environmental friendliness. Their working principle is similar to that of lithium-ion batteries, mainly utilizing a back-and-forth intercalation and deintercalation of sodium ions between positive and negative electrodes to achieve energy storage and release. At present, a positive electrode material for sodium-ion battery is mainly divided into three categories: transition metal oxide, polyanion compound, and Prussian blue analog. Among them, transition metal oxide has received extensive attention and research from researchers due to its highest theoretical specific capacity. However, when used as the positive electrode, the transition metal oxide has strong oxidizing property, which easily leads to gas generation in the battery and causes safety issue.

### SUMMARY

In order to address the problem of gas generation in sodium-ion battery observed in conventional technology, the present disclosure aims to provide a sodium-ion battery that significantly mitigates gas generation during cycling process by adjusting a content of the metallic M element in a positive electrode active substance and a composition of an electrolyte solution.

The object of the present disclosure is achieved through the following technical solutions.

A sodium-ion battery, where the sodium-ion battery includes a positive electrode plate, a negative electrode plate, a separator, and an electrolyte solution; the positive electrode plate includes a positive electrode active substance, the positive electrode active substance includes metallic Na element, metallic Ni element, metallic Fe element, metallic Mn element, and metallic M element, the metallic M element is one or more selected from Li, Mg, Zn, Co, Ca, Ba, Sr, Al, B, Cr, V, Zr, Ti, Sn, Mo, Ru, Si, Sb, Nb or Te; the electrolyte solution includes vinylene carbonate and optionally added or non-added ethylene carbonate;
the battery satisfies the following relationship:

$$0 \leq {w}_{1} \leq 30 \% ;$$

$$0 \leq {w}_{1} / ( {w}_{2} + d ) \leq 5 ;$$

where w₁ is a mass content of ethylene carbonate in a total mass of the electrolyte solution, w2 is a mass content of vinylene carbonate in the total mass of the electrolyte solution, d is a molar amount of M element per mole of the positive electrode active substance.

Beneficial effects of the present disclosure are:

The present disclosure provides a sodium-ion battery, which can significantly mitigate the gas generation problem of the sodium-ion battery during the cycling process by adjusting a content of the metallic M element in a positive electrode active substance and a composition of an electrolyte solution. Specifically, when the electrolyte solution includes ethylene carbonate (EC), the EC in the electrolyte solution chemically reacts with transition metal in a positive electrode active substance, generating gas and deteriorating the battery's performance. By doping the positive electrode active substance with metallic M element and adding vinylene carbonate (VC) to the electrolyte solution, the metallic M element can effectively promote VC to form a film preferentially on the positive electrode. By regulating the mass content of ethylene carbonate in the total mass of the electrolyte solution (w₁), the mass content of vinylene carbonate in the total mass of the electrolyte solution (w₂), and the molar amount of the M element per mole of the positive electrode active substance (d), so that they satisfy 0≤w₁≤30% and 0≤w₁/(w₂+d)≤5, the above-mentioned reaction can be effectively prevented, the stability of the sodium-ion battery can be greatly improved, and the gas generation phenomenon can be reduced.

### DETAILED DESCRIPTIONS OF THE EMBODIMENTS

The following is a detailed description of the specific implementations of the present disclosure. It should be understood that the specific implementations described herein are only used to illustrate and explain the present disclosure, and are not used to limit the present disclosure.

Unless otherwise defined, all scientific and technical terms used in the present disclosure have the same meaning as commonly understood by those skilled in the technical field related to the present disclosure.

The present disclosure provides a sodium-ion battery, where the sodium-ion battery includes a positive electrode plate, a negative electrode plate, a separator, and an electrolyte solution; the positive electrode plate includes a positive electrode active substance, the positive electrode active substance includes metallic Na element, metallic Ni element, metallic Fe element, metallic Mn element, metallic M element, the metallic M element is one or more selected from Li, Mg, Zn, Co, Ca, Ba, Sr, Al, B, Cr, V, Zr, Ti, Sn, Mo, Ru, Si, Sb, Nb or Te; the electrolyte solution includes vinylene carbonate and optionally added or non-added ethylene carbonate;
the battery satisfies the following relationship:

$$0 \leq {w}_{1} \leq 30 \% ;$$

$$0 \leq {w}_{1} / ( {w}_{2} + d ) \leq 5 ;$$

where w₁ is a mass content of ethylene carbonate in a total mass of the electrolyte solution, w2 is a mass content of vinylene carbonate in the total mass of the electrolyte solution, d is a molar amount of M element per mole of the positive electrode active substance.

The present disclosure has found through research that when the electrolyte solution includes ethylene carbonate (EC), the EC in the electrolyte solution will react with transition metals (such as Ni, Fe, and Mn) in a positive electrode active substance through the following reactions:

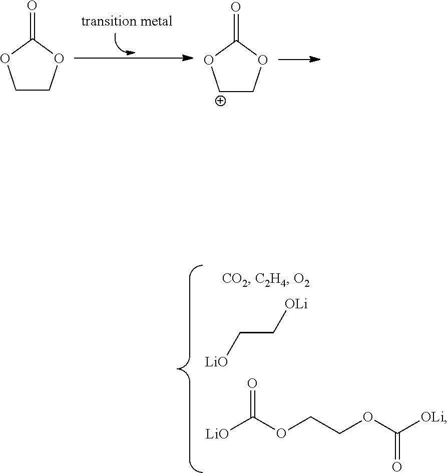

this reaction easily leads to gas generation in the battery and causes safety issues.

By doping the positive electrode active substance with the metallic M element and adding vinylene carbonate (VC) to the electrolyte solution, the metallic M element can effectively promote vinylene carbonate to preferentially form a film on the positive electrode, thereby preventing EC from reacting on the positive electrode surface to generate gas; and by regulating the mass content of ethylene carbonate in the total mass of the electrolyte solution (w₁), the mass content of vinylene carbonate in the total mass of the electrolyte solution (w₂), and the molar amount of the M element per mole of the positive electrode active substance (d), so that they satisfy 0≤w₁≤30% and 0≤w₁/(w₂+d)≤5 are satisfied, the solid electrolyte interphase (SEI) film formed by VC on the positive electrode surface has higher strength, which can effectively prevent the above-mentioned reaction, greatly improve the stability of the sodium-ion battery, and reduce the occurrence of gas generation.

EC has a film-forming effect on the negative electrode surface, which can effectively inhibit the continuous decomposition of the electrolyte solution and the structural degradation of the negative electrode material. If EC is completely absent in the electrolyte solution, the capacity retention performance of the battery will instead decline.

According to the embodiments of the present disclosure, 0≤w₁/(w₂+d)≤3. For example, the value of w₁/(w₂+d) can be 0, 0.1, 0.2, 0.5, 0.8, 1, 1.2, 1.5, 1.8, 2, 2.2, 2.5, 2.8, 3, 3.2, 3.5, 3.8, 4, 4.5, 5 or any value within the range formed by any two of the above values.

According to the embodiments of the present disclosure, the mass content of ethylene carbonate in the total mass of the electrolyte solution w₁ is 0, 1%, 2%, 5%, 8%, 10%, 15%, 20%, 25%, 30% or any value within the range formed by any two of the above values, preferably 8%-25%.

According to the embodiments of the present disclosure, the mass content of vinylene carbonate in the total mass of the electrolyte solution w₂ is 0.1%-10%, for example 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10% or any value within the range formed by any two of the above values, preferably 0.5%-5%.

According to the embodiments of the present disclosure, d is greater than 0 and less than 1, preferably, a value of d is 0.001-0.1, for example 0.001, 0.002, 0.005, 0.008, 0.01, 0.02, 0.03, 0.04, 0.05, 0.06, 0.07, 0.08, 0.09, 0.1 or any value within the range formed by any two of the above values. When the molar amount of the M element is within the range 0.001 to 0.1, it can better promote vinylene carbonate to form a SEI film and improve the strength of the SEI film.

According to the embodiments of the present disclosure, the electrolyte solution further includes a compound represented by Formula I:

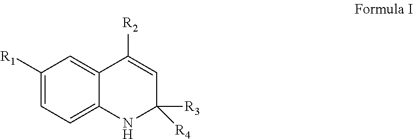

in Formula I, R₁ is selected from alkoxy group; R₂, R₃, R₄ are the same or different and are each independently selected from alkyl group.

According to the embodiments of the present disclosure, R₁ is selected from C₁₋₁₂ alkoxy group; R₂, R₃, R₄ are the same or different and are each independently selected from C₁₋₁₂ alkyl group.

According to the embodiments of the present disclosure, R₁ is selected from C₁₋₆ alkoxy group; R₂, R₃, R₄ are the same or different and are each independently selected from C₁₋₆ alkyl group.

According to the embodiments of the present disclosure, R₁ is selected from C₁₋₃ alkoxy group; R₂, R₃, R₄ are the same or different and are each independently selected from C₁₋₃ alkyl group.

According to the embodiments of the present disclosure, the compound represented by Formula I is specifically selected from a compound represented by following Formula A:

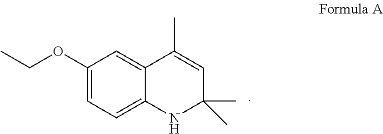 [SMILES: CCOc1ccc2c(c1)C(C)=CC(C)(C)N2]

According to the embodiments of the present disclosure, a mass content of the compound represented by Formula I is 0.1%-5% of the total mass of the electrolyte solution, preferably 1%-2%, such as 0.1%, 0.5%, 1.0%, 1.1%, 1.2%, 1.3%, 1.4%, 1.5%, 1.6%, 1.7%, 1.8%, 1.9%, 2% or any value within the range formed by any two of the above values.

According to the embodiments of the present disclosure, the introduction of the compound represented by Formula I can further inhibit the gas generation issue during the battery cycling process. This is mainly because the compound represented by Formula I can effectively form protective films on both the positive and negative electrode surfaces of the sodium-ion battery. Moreover, the protective film formed on the positive electrode surface can synergistically interact with the protective film formed by VC on the positive electrode surface, further inhibiting the reactions of electrolyte components on the positive and negative electrodes. When the content of the compound represented by Formula I is 1%/6-2%, the formed SEI film has an optimal thickness, and the obtained battery exhibits a best performance.

According to the embodiments of the present disclosure, the electrolyte solution includes a sodium salt, where the sodium salt is one or more selected from sodium hexafluorophosphate (NaPF₆), sodium tetrafluoroborate (NaBF₄), sodium perchlorate (NaClO₄), sodium hexafluoroarsenate (NaAsF₆), sodium hexafluoroantimonate (NaSbF₆), sodium difluorophosphate (NaPF₂O₂), sodium 4,5-dicyano-2-trifluoromethy limidazole (NaDTI), sodium bis(oxalato)borate (NaBOB), sodium bis(malonato)borate (NaBMB), sodium difluoro(oxalato)borate (NaDFOB), sodium bis(difluoromalonato)borate (NaBDFMB), sodium (malonatooxalato)borate (NaMOB), sodium (difluoromalonatooxalato)borate (NaDFMOB), sodium tris(oxalato)phosphate (NaTOP), sodium tris(difluoromalonato)phosphate (NaTDFMP), sodium tetrafluoro(oxalato)phosphate (NaTFOP), sodium difluorobis(oxalato)phosphate (NaDFOP), sodium bis(fluorosulfonyl)imide (NaFSI), sodium bis(trifluoromethanesulfonyl)imide (NaTFSI), sodium (fluorosulfonyl)(trifluoromethanesulfonyl)imide (NaN(SO₂F)(SO₂CF₃)), sodium nitrate (NaNO₃) or sodium fluoride (NaF).

According to the embodiments of the present disclosure, a concentration of the sodium salt in the electrolyte solution is 0.2 mol/L-2.0 mol/L, for example, 0.2 mol/L, 0.5 mol/L, 0.8 mol/L, 1 mol/L, 1.2 mol/L, 1.5 mol/L, 1.8 mol/L, 2.0 mol/L or any value within the range formed by any two of the above values. When the concentration of the sodium salt in the electrolyte solution is within the above range, it can accelerate the rate of electrochemical reaction and improve the conductivity of the electrolyte solution.

According to the embodiments of the present disclosure, the electrolyte solution includes an organic solvent, and the organic solvent is selected from one or more of propylene carbonate (PC), butylene carbonate, difluoroethylene carbonate (DFEC), fluorodimethyl carbonate, fluoroethyl methyl carbonate, dimethyl carbonate (DMC), diethyl carbonate (DEC), dipropyl carbonate, ethyl methyl carbonate (EMC), methyl formate, ethyl formate, propyl formate, butyl formate, methyl acetate, ethyl acetate (EA), propyl acetate, butyl acetate, methyl propionate, ethyl propionate, propyl propionate, butyl propionate, methyl butyrate, ethyl butyrate, propyl butyrate, butyl butyrate, methyl difluoroacetate, ethyl difluoroacetate, γ-butyrolactone (GBL), γ-valerolactone, δ-valerolactone, ethylene glycol dimethyl ether (DME), triethylene glycol dimethyl ether, tetraethylene glycol dimethyl ether, ethyl perfluoroethyl ether (F-EPE), difluoroethyl ether (D2), hexafluoropropyl methyl ether (HFPM), methyl fluoroethyl ether (MFE), ethyl methyl fluoroether (EME), tetrahydrofuran (THF), 2-methyltetrahydrofuran, 1,3-dioxolane (DOL), 1,4-dioxane (DOX), sulfolane, dimethyl sulfoxide (DMSO), dichloromethane or dichloroethane.

According to the embodiments of the present disclosure, a chemical formula of the positive electrode active substance is NaₓNiₐFe_{b}Mn_{c}M_{d}O₂, where 0<a<1, 0<b<1, 0<c<1, 0<d<1, and a+b+c+d=1, 0.7≤x≤1.0; M is one or more selected from Li, Mg, Zn, Co, Ca, Ba, Sr, Al, B, Cr, V, Zr, Ti, Sn, Mo, Ru, Si, Sb, Nb or Te.

According to the embodiments of the present disclosure, the positive electrode active substance has a polycrystalline morphology or a single-crystal morphology.

According to the embodiments of the present disclosure, where a Dv50 of the positive electrode active substance is 15 μm-20 μm, for example, 15 μm, 16 μm, 17 μm, 18 μm, 19 μm, 20 μm, or any value within the range formed by any two of the above values. When the Dv50 of the positive electrode active substance is within the above range, it can provide larger surface areas of the active material, increase reaction sites for sodium ion intercalation, and improve the capacity and cycle life of the battery.

According to the embodiments of the present disclosure, the positive electrode active substance is prepared by the following method: a coprecipitate is obtained by a coprecipitation method using a soluble Ni salt, a soluble Fe salt, a soluble Mn salt, and a soluble salt containing the M element, and the coprecipitate is mixed with sodium nitrate and sintered to obtain the positive electrode active substance. Where a sintering temperature is 700° C.-1000° C., a sintering time is 12 h-40 h, and a sintering atmosphere is air or oxygen.

According to the embodiments of the present disclosure, a press density of the positive electrode plate is 4.0 g/cm³-4.4 g/cm³, for example, 4.0 g/cm³, 4.1 g/cm³, 4.2 g/cm³, 4.3 g/cm³, 4.4 g/cm³, or any value within the range formed by any two of the above values. When the press density of the positive electrode plate is within the above range, it can increase the contact area between the positive electrode active substance and ions in the electrolyte solution, promote the progress of electrochemical reactions, improve an ion diffusion rate, thereby reducing the internal resistance of the electrode and improving the capacity and cycle life of the battery.

According to the embodiments of the present disclosure, the positive electrode plate includes a positive electrode current collector and a positive electrode active material layer; the positive electrode active material layer is coated on a surface of the positive electrode current collector; the positive electrode active material layer includes a positive electrode active material, and the positive electrode active material is the above-mentioned positive electrode active substance.

According to the embodiments of the present disclosure, the positive electrode active material layer in the positive electrode plate further includes a positive electrode conductive agent and a positive electrode binder.

According to the embodiments of the present disclosure, the positive electrode conductive agent includes, but is not limited to: a carbon-based material, a metal-based material, a conductive polymer, or mixtures thereof. In some embodiments, the carbon-based material is selected from natural graphite, artificial graphite, carbon black, acetylene black, Keqin black, carbon fiber, or any combination thereof. In some embodiments, the metal-based material is selected from metal powder, metal fiber, copper, nickel, aluminum, and silver. In some embodiments, the conductive polymer is a polyphenylene derivative.

According to the embodiments of the present disclosure, the positive electrode binder includes, but is not limited to: polyvinylidene fluoride (PVDF), polytetrafluoroethylene (PTFE), styrene-butadiene rubber (SBR), nitrile butadiene rubber (NBR), aqueous acrylic resin, polyvinyl alcohol, polyvinyl butyral, polyurethane, fluororubber, carboxymethyl cellulose (CMC) or polyacrylic acid (PAA).

According to the embodiments of the present disclosure, a mass percentage of each component in the positive electrode active material layer of the positive electrode plate is: 75 wt %-98 wt % positive electrode active material, 1 wt %-15 wt % positive electrode conductive agent, 1 wt %-10 wt % positive electrode binder.

Preferably, the mass percentage of each component in the positive electrode active material layer of the positive electrode plate is: 82 wt %-96 wt % positive electrode active material, 2 wt %-10 wt % positive electrode conductive agent, and 2 wt %-8 wt % positive electrode binder.

According to the embodiments of the present disclosure, the positive electrode current collector includes, but is not limited to: aluminum foil, carbon-coated aluminum foil, perforated aluminum foil, stainless steel foil, a polymer substrate coated with a conductive metal, or any combination thereof.

According to the embodiments of the present disclosure, the positive electrode plate can be prepared by conventional method in the conventional technology. Typically, the positive electrode active material, optional positive electrode conductive agent, and positive electrode binder are dispersed in a solvent (such as N-Methylpyrrolidone (NMP)) to form a uniform positive electrode slurry, the positive electrode slurry is coated on the positive electrode current collector, and after processes such as drying, the positive electrode plate is obtained.

According to the embodiments of the present disclosure, the separator is one of a polypropylene separator (PP), a polyethylene separator (PE), a polypropylene/polyethylene double-layer composite membrane (PP/PE), a polypropylene/polyethylene/polypropylene three-layer composite membrane (PP/PE/PP), a polyimide electrospun separator (PI), a cellulose non-woven separator, a polyethylene terephthalate non-woven separator (PET), or a separator with a ceramic coating.

According to the embodiments of the present disclosure, the separator is positioned between the positive electrode plate and the negative electrode plate to serve an isolating function.

According to the embodiments of the present disclosure, the negative electrode plate includes a negative electrode current collector and a negative electrode active material layer; the negative electrode active material layer is coated on the surface of the negative electrode current collector; the negative electrode active material layer includes a negative electrode active material.

According to the embodiments of the present disclosure, the negative electrode active material in the negative electrode plate is, for example, selected from at least one of natural graphite, artificial graphite, mesocarbon microbead, hard carbon, soft carbon, Sn, SnO, SnO₂, Sb, Sb₂O₃, Bi, Bi₂O₃ or TiO₂, etc. Exemplarily, the negative electrode active material in the negative electrode plate is selected from hard carbon.

According to the embodiments of the present disclosure, the negative electrode active material layer in the negative electrode plate further includes a negative electrode conductive agent and a negative electrode binder.

According to the embodiments of the present disclosure, the negative electrode conductive agent includes, but is not limited to: a carbon-based material, a metal-based material, a conductive polymer, or mixtures thereof. In some embodiments, the carbon-based material is selected from natural graphite, artificial graphite, carbon black, acetylene black, Keqin black, carbon fiber, or any combination thereof. In some embodiments, the metal-based material is selected from metal powder, metal fiber, copper, nickel, aluminum, and silver. In some embodiments, the conductive polymer is a polyphenylene derivative.

According to the embodiments of the present disclosure, the negative electrode binder includes, but is not limited to: polyvinylidene fluoride (PVDF), polytetrafluoroethylene (PTFE), styrene-butadiene rubber (SBR), nitrile butadiene rubber (NBR), aqueous acrylic resin, polyvinyl alcohol, polyvinyl butyral, polyurethane, fluororubber, carboxymethyl cellulose (CMC), polyacrylic acid (PAA), epoxy resin, hydroxypropyl cellulose, diacetyl cellulose, polyvinyl chloride, carboxylated polyvinyl chloride, polyvinylpyrrolidone, or nylon.

According to the embodiments of the present disclosure, a mass percentage of each component in the negative electrode active material layer of the negative electrode plate is: 75 wt %-98 wt % negative electrode active material, 1 wt %-15 wt % negative electrode conductive agent, and 1 wt %-10 wt % negative electrode binder.

Preferably, the mass percentage of each component in the negative electrode active material layer of the negative electrode plate is: 82 wt %-96 wt % negative electrode active material, 2 wt %-10 wt % negative electrode conductive agent, and 2 wt %-8 wt % negative electrode binder.

According to the embodiments of the present disclosure, the negative electrode current collector includes, but is not limited to: copper foil, carbon-coated copper foil, perforated copper foil, nickel foil, stainless steel foil, titanium foil, nickel foam, copper foam, a polymer substrate coated with a conductive metal, and any combination thereof.

According to the embodiments of the present disclosure, the negative electrode plate can be prepared by conventional method in the conventional technology. Typically, the negative electrode active material, optional negative electrode conductive agent and negative electrode binder are dispersed in a solvent (such as deionized water) to form a uniform negative electrode slurry, the negative electrode slurry is coated on the negative electrode current collector, and after processes such as drying, the negative electrode plate is obtained.

According to the embodiments of the present disclosure, the charge cut-off voltage of the sodium-ion battery is less than 4.1 V.

Research has found that when the charge cut-off voltage of the sodium-ion battery is greater than or equal to 4.1 V, the catalytic oxidation performance of transition metal at the positive electrode end will be extremely enhanced, resulting in a significant deterioration in the battery's performance.

The following will further describe the present disclosure in detail in conjunction with specific embodiments. It should be understood that the following embodiments are only for exemplarily illustrating and explaining the present disclosure, and should not be construed as limiting the protection scope of the present disclosure. All technologies implemented based on the above content of the present disclosure are covered within the protection scope intended by the present disclosure.

Unless otherwise specified, the experimental methods used in the following embodiments are conventional methods; unless otherwise specified, the reagents, materials, etc. used in the following embodiments can all be obtained from commercial sources.

### Preparation Example 1

### Preparation of a Positive Electrode Active Substance

(1) First, soluble Ni salt (nickel sulfate), Fe salt (iron sulfate), Mn salt (manganese sulfate), and soluble salt containing M element (such as aluminum sulfate, magnesium nitrate, zinc nitrate, boric acid, cobalt nitrate, tin nitrate, etc.) were mixed according to a stoichiometric ratio (molar ratio), and added them to a solvent to obtain a mixed solution, in which a stoichiometric ratio of Ni/Fe/Mn was 1:1:1, and a stoichiometric amount of the M element was d. An appropriate amount of ammonia water was slowly added to the mixed solution while maintaining stirring, and a pH value of the solution was 11.5±0.2, to obtain a coprecipitate containing Ni, Fe, Mn, and M; after filtration, the coprecipitate was washed with deionized water and kept for further use;
(2) The composite precursor obtained in step (1) was washed with deionized water, dried, mixed uniformly with sodium carbonate according to a stoichiometric ratio, and subjected to high-temperature sintering: a sintering temperature was 1000° C., and a sintering time was 24 h; a sintering atmosphere was air;
(3) The obtained sintered product was ground to prepare the positive electrode active substance. The Dv50 of the positive electrode active substance was 15 μm-20 μm, and the morphology of the positive electrode active substance was polycrystalline morphology.

### Preparation Example 2

### Preparation of an Electrolyte Solution

In an argon-filled glove box (H₂O≤0.1 ppm, O₂<0.1 ppm), propylene carbonate (PC) and diethyl carbonate (DEC) were mixed uniformly in a mass ratio of 2:7, then 12.5 wt % (based on the total mass of the electrolyte solution) of thoroughly dried sodium hexafluorophosphate (NaPF₆) was added and dissolved. Subsequently, ethylene carbonate (EC) with a mass of w₁ based on the total mass of the electrolyte solution and vinylene carbonate (VC) with a mass of w₂ based on the total mass of the electrolyte solution were added, and the mixture was stirred uniformly. After passing tests for moisture and free acid, the required electrolyte solution was obtained.

### Preparation Example 3

### Preparation of a Positive Electrode Plate

The positive electrode active substance prepared in Preparation Example 1, conductive agent carbon black, and binder polyvinylidene fluoride (PVDF) were weighed in a weight ratio of 95:2.5:2.5 and dispersed in an appropriate amount of N-methylpyrrolidone. The mixture was thoroughly stirred to form a uniform positive electrode slurry. The positive electrode slurry was coated on an aluminum foil serving as a positive electrode current collector, and then dried, roll-pressed, and cut to obtain a positive electrode plate. The press density of the positive electrode plate was 4.0 g/cm³-4.4 g/cm³.

### Preparation Example 4

### Preparation of a Negative Electrode Plate

Negative electrode active substance hard carbon, conductive agent carbon black, binder styrene-butadiene rubber (SBR), and thickener sodium carboxymethyl cellulose (CMC) were weighed in a weight ratio of 90:2.5:5.0:2.5 and dispersed in an appropriate amount of deionized water, The mixture was thoroughly stirred to form a uniform negative electrode slurry. The negative electrode slurry was coated on a copper foil serving as a negative electrode current collector, and then dried, roll-pressed, and cut to obtain a negative electrode plate.

### Preparation Example 5

### Preparation of a Sodium-Ion Battery

The above positive electrode, negative electrode, and separator were stacked in sequence, with a separator placed between the positive electrode and the negative electrode. After tab welding and winding, a jelly roll was obtained. The jelly roll was placed in an aluminum-plastic film packaging bag, and then the above electrolyte solution was injected. After vacuum sealing, standing, formation, shaping, and other processes, a sodium-ion battery was obtained.

### Test Example 1

### Full Battery Gas Generation Test

A sodium-ion battery was placed at 25° C., charged at a constant current of 0.5 C to the upper voltage limit (4.0 V), then charged at a constant voltage of 4.0 V until the current dropped to 0.05 C, and allowed to stand for 5 min; subsequently, the battery was discharged at a constant current of 0.5 C to a lower voltage limit of 1.5 V, and allowed to stand for 5 min. This constituted one charge-discharge cycle. Charging/discharging was performed in this manner, and the number of cycles in which the sodium-ion battery generated gas was recorded.

### Test Example 2

### Cycling Test at 25° C.

A sodium-ion battery was placed in an environment maintained at (25±2)° C. and allowed to stand for 2-3 hours. When the battery body reached (25±2)° C., the battery was charged at a constant current of 1.5 C until the cutoff current of 0.05 C was reached. After full charge, the battery was stand for 5 minutes, then discharged at a constant current of 0.7 C to a cutoff voltage of 3.0 V. The highest discharge capacity recorded during the first three cycles was defined as the initial capacity Q. When gas generation was observed during cycling, the last discharge capacity Q1 and the corresponding cycle number were recorded.

The capacity retention rate (%)=Q1/Q×100%.

### Examples 1-16 and Comparative Examples 1-7

The sodium-ion batteries of Examples 1-16 and Comparative Examples 1-7 were all manufactured using the above methods of Preparation Examples 1-5 and tested using the above method of Test Example 1. The differences lie in the content of metallic M element in the positive electrode active substance and the contents of VC and EC in the electrolyte solution. The details are shown in the following table 1:

TABLE 1

| | | Content | | | | Number | Cycle |
|---|---|---|---|---|---|---|---|
| | Doped | of doped | Content | Content | | of cycles | capacity |
| | element | element | of EC | of VC | w₁/ | until gas | retention |
| No. | (M) | (d) | (w₁) | (w₂) | (w₂ + d) | generation | rate |
| Example 1 | Al | 0.04 | 8.65% | 1.0% | 1.73 | 644 | 78% |
| Example 2 | Al | 0.05 | 20% | 2.0% | 2.86 | 571 | 72% |
| Example 3 | Mg | 0.05 | 20% | 2.0% | 2.86 | 575 | 72% |
| Example 4 | Zn | 0.05 | 20% | 2.0% | 2.86 | 629 | 77% |
| Example 5 | Co | 0.05 | 20% | 2.0% | 2.86 | 613 | 77% |
| Example 6 | Ca | 0.05 | 20% | 2.0% | 2.86 | 609 | 76% |
| Example 7 | B | 0.05 | 20% | 2.0% | 2.86 | 636 | 77% |
| Example 8 | Sn | 0.05 | 20% | 2.0% | 2.86 | 569 | 70% |
| Example 9 | Ti | 0.05 | 20% | 2.0% | 2.86 | 636 | 78% |
| Example 10 | Al | 0.05 | / | 2.0% | 0 | 597 | 50% |
| Example 11 | Al | 0.05 | 10% | 2.0% | 1.43 | 633 | 77% |
| Example 12 | Al | 0.05 | 10% | 1.0% | 1.67 | 560 | 70% |
| Example 13 | Al | 0.03 | 10% | 2.0% | 2 | 592 | 71% |
| Example 14 | Al | 0.05 | 15% | 2.0% | 2.14 | 640 | 78% |
| Example 15 | Al | 0.05 | 25% | 2.0% | 3.57 | 420 | 65% |
| Example 16 | Al | 0.05 | 20% | 1.0% | 3.33 | 450 | 64% |
| Example 17a | Al | 0.001 | 10% | 2.0% | 4.76 | 453 | 64% |
| Example 17b | Al | 0.1 | 20% | 2.0% | 1.67 | 496 | 64% |
| Example 17c | Al | 0.0005 | 10% | 2.0% | 4.87 | 239 | 60% |
| Example 17d | Al | 0.12 | 20% | 2.0% | 1.43 | 398 | 62% |
| Example 18a | Al | 0.05 | 20% | 0.1% | 3.92 | 493 | 65% |
| Example 18b | Al | 0.05 | 20% | 10% | 1.33 | 465 | 64% |
| Example 18c | Al | 0.05 | 20% | 0.05% | 3.96 | 349 | 61% |
| Example 18d | Al | 0.05 | 20% | 15% | 1 | 294 | 62% |
| Comparative | Al | 0.08 | 35% | 5.0% | 2.69 | 75 | 33% |
| Example 1 | | | | | | | |
| Comparative | Mg | 0.08 | 35% | 5.0% | 2.69 | 65 | 34% |
| Example 2 | | | | | | | |
| Comparative | Al | 0.02 | 20% | 0.5% | 8 | 89 | 32% |
| Example 3 | | | | | | | |
| Comparative | Mg | 0.02 | 20% | 0.5% | 8 | 91 | 29% |
| Example 4 | | | | | | | |
| Comparative | / | / | 20% | 2.0% | 10 | 102 | 30% |
| Example 5 | | | | | | | |
| Comparative | Al | 0.05 | 20% | / | 4 | 121 | 31% |
| Example 6 | | | | | | | |
| Comparative | / | / | / | / | / | 51 | 30% |
| Example 7 | | | | | | | |

Note:
When calculating w₁/(w₂ + d), the units of w₁ and w₂ were %, and only the numerical values of w₁ and w₂ were substituted for calculation. The value of d was also converted into a percentage (%) for calculation. Taking Example 1 as an example, w₁ was 8.65%, w₂ was 1.0%, d was 0.04 (i.e., 4.0%), and w₁/(w₂ + d) = 8.65/(1.0 + 4.0) = 1.73.

As can be seen from the table 1 above, by doping the positive electrode active substance with the metallic M element and adding VC to the electrolyte solution, the metallic M element can effectively promote VC to preferentially form a film on the positive electrode. By regulating the mass content of ethylene carbonate in the total mass of the electrolyte solution, the mass content of vinylene carbonate in the total mass of the electrolyte solution, and the molar amount of the M element per mole of the positive electrode active substance, so that they satisfy 0≤w₁≤30% and 0≤w₁/(w₂+d)≤5, the occurrence of side reaction can be effectively prevented, the stability of the sodium-ion battery can be greatly improved, and the gas generation phenomenon can be reduced.

The sodium-ion batteries of Examples 2.1-6.1 were all manufactured using the above methods of the Preparation Examples and tested using the above method of Test Example 1. The difference is that the additive represented by Formula A was further added to the electrolyte solution. The details are shown in the following table 2:

TABLE 2

| | | Content | | | | Additive | Number |
|---|---|---|---|---|---|---|---|
| | Doped | of doped | Content | Content | | shown in | of cycles |
| | element | element | of EC | of VC | w₁/ | Formula | until gas |
| No. | (M) | (d) | (w₁) | (w₂) | (w₂ + d) | A | generation |
| Example 2 | Al | 0.05 | 20% | 2.0% | 2.86 | / | 571 |
| Example 2.1 | Al | 0.05 | 20% | 2.0% | 2.86 | 1.10% | 783 |
| Example 3 | Mg | 0.05 | 20% | 2.0% | 2.86 | / | 575 |
| Example 3.1 | Mg | 0.05 | 20% | 2.0% | 2.86 | 1.10% | 744 |
| Example 4 | Zn | 0.05 | 20% | 2.0% | 2.86 | / | 629 |
| Example 4.1 | Zn | 0.05 | 20% | 2.0% | 2.86 | 1.10% | 712 |
| Example 5 | Co | 0.05 | 20% | 2.0% | 2.86 | / | 613 |
| Example 5.1 | Co | 0.05 | 20% | 2.0% | 2.86 | 1.10% | 725 |
| Example 6 | Ca | 0.05 | 20% | 2.0% | 2.86 | / | 609 |
| Example 6.1 | Ca | 0.05 | 20% | 2.0% | 2.86 | 1.10% | 738 |
| Example 18e | Al | 0.05 | 20% | 0.05% | 3.96 | 1.10% | 453 |
| Example 18f | Al | 0.05 | 20% | 15% | 1 | 1.10% | 497 |
| Example 19a | Al | 0.05 | 20% | 2.0% | 2.86 | 0.1% | 438 |
| Example 19b | Al | 0.05 | 20% | 2.0% | 2.86 | 5% | 378 |
| Example 19c | Al | 0.05 | 20% | 2.0% | 2.86 | 0.05% | 267 |
| Example 19d | Al | 0.05 | 20% | 2.0% | 2.86 | 8% | 269 |
| Comparative | Al | 0.02 | 20% | 0.5% | 8 | / | 89 |
| Example 3 | | | | | | | |
| Comparative | Mg | 0.02 | 20% | 0.5% | 8 | / | 91 |
| Example 4 | | | | | | | |

As can be seen from the table 2 above, by doping the positive electrode active substance with the metallic M element and adding VC to the electrolyte solution, the metallic M element can effectively promote VC to preferentially form a film on the positive electrode. The further introduction of the compound represented by Formula I can further effectively inhibit the gas generation issue during the battery cycling process. This is mainly because the compound represented by Formula I can effectively form protective films on both the positive and negative electrodes surfaces of the sodium-ion battery, inhibiting reactions of electrolyte solution components on the positive and negative electrodes. When the content of the compound represented by Formula I is 1.1%, the formed solid electrolyte interphase (SEI) has the optimal thickness, and the obtained battery exhibits a best performance. Conversely, when the compound represented by Formula I is used in combination with batteries that do not satisfy 0≤w₁≤30% and 0≤w₁/(w₂+d)≤5, the compound has no improvement effect on cyclic gas generation and may even have a possibility of causing certain deterioration.

The sodium-ion batteries of Examples 1.1-1.3 were all manufactured using the above methods of the Preparation Examples and tested using the above method of Test Example 1. The difference lies in the charge voltage range. The details are shown in the following table 3:

TABLE 3

| | | Content | | | | | Number |
|---|---|---|---|---|---|---|---|
| | Doped | of doped | Content | Content | | Charge | of cycles |
| | element | element | of | of | w₁/ | cut-off | until gas |
| No. | (M) | (d) | EC(w₁) | VC(w₂) | (w₂ + d) | voltage | generation |
| Example 1 | Al | 0.04 | 8.65% | 1.0% | 1.73 | 4.0 V | 644 |
| Example 1.1 | Al | 0.04 | 8.65% | 1.0% | 1.73 | 3.9 V | 678 |
| Example 1.2 | Al | 0.04 | 8.65% | 1.0% | 1.73 | 4.1 V | 75 |
| Example 1.3 | Al | 0.04 | 8.65% | 1.0% | 1.73 | 4.3 V | 66 |

As can be seen from the table 3 above, when the charge cut-off voltage of the sodium-ion battery is greater than or equal to 4.1 V, the catalytic oxidation performance of transition metal at the positive electrode end will be drastically enhanced, leading to a significant deterioration in the battery's performance.

### Example Group 20

Example 20a was carried out with reference to Example 2, differing in that the Dv50 of the positive electrode active substance was 30 μm-35 μm; the number of cycles with gas generation was 496.

Example 20b was carried out with reference to Example 2, differing in that the press density of the positive electrode plate was 3.5 g/cm³-3.8 g/cm³; the number of cycles with gas generation was 398.

The above describes the embodiments of the present disclosure. However, the present disclosure is not limited to the above embodiments. Any modifications, equivalent substitutions, improvements, etc. made within the spirit and principles of the present disclosure should be included in the protection scope of the present disclosure.

What is claimed is:

1. A sodium-ion battery, comprising a positive electrode plate, a negative electrode plate, a separator and an electrolyte solution; wherein the positive electrode plate comprises a positive electrode active substance, the positive electrode active substance comprises metallic Na element, metallic Ni element, metallic Fe element, metallic Mn element, and metallic M element, the metallic M element is one or more selected from Li, Mg, Zn, Co, Ca, Ba, Sr, Al, B, Cr, V, Zr, Ti, Sn, Mo, Ru, Si, Sb, Nb or Te; the electrolyte solution comprises vinylene carbonate and optionally added or non-added ethylene carbonate;
the battery satisfies the following relationship:
$$0 \leq {w}_{1} \leq 30 \% ;$$
$$0 \leq {w}_{1} / ( {w}_{2} + d ) \leq 5 ;$$
wherein w₁ is a mass content of ethylene carbonate in a total mass of the electrolyte solution, w2 is a mass content of vinylene carbonate in the total mass of the electrolyte solution, d is a molar amount of M element per mole of the positive electrode active substance.

2. The sodium-ion battery according to claim 1, wherein w₂ is 0.1%-10%.

3. The sodium-ion battery according to claim 1, wherein w₂ is 0.5%-5%.

4. The sodium-ion battery according to claim 1, wherein w₁ is 8%-25%.

5. The sodium-ion battery according to claim 1, wherein d is greater than 0 and less than 1.

6. The sodium-ion battery according to claim 1, wherein a value of d is 0.001-0.1.

7. The sodium-ion battery according to claim 1, wherein 0≤w₁/(w₂+d)≤3.

8. The sodium-ion battery according to claim 1, wherein the electrolyte solution further comprises a compound represented by Formula I: 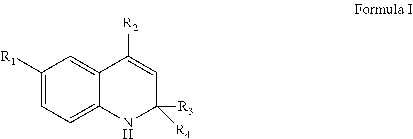
in Formula I, R₁ is selected from alkoxy group; R₂, R₃, R₄ are the same or different and are each independently selected from alkyl group.

9. The sodium-ion battery according to claim 8, wherein R₁ is selected from C₁₋₁₂ alkoxy group; R₂, R₃, R₄ are the same or different and are each independently selected from C₁₋₁₂ alkyl group.

10. The sodium-ion battery according to claim 8, wherein the compound represented by Formula I is specifically selected from a compound represented by following Formula A:

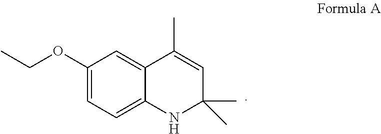 [SMILES: CCOc1ccc2c(c1)C(C)=CC(C)(C)N2]

11. The sodium-ion battery according to claim 8, wherein a mass content of the compound represented by Formula I is 0.1%-5% of a total mass of the electrolyte solution.

12. The sodium-ion battery according to claim 11, wherein the mass content of the compound represented by Formula I is 1%-2% of a total mass of the electrolyte solution.

13. The sodium-ion battery according to claim 1, wherein a chemical formula of the positive electrode active substance is NaₓNiₐFe_{b}Mn_{c}M_{d}O₂, 0<a<1, 0<b<1, 0<c<1, 0<d<1, and a+b+c+d=1, 0.7≤x≤1.0; M is one or more selected from Li, Mg, Zn, Co, Ca, Ba, Sr, Al, B, Cr, V, Zr, Ti, Sn, Mo, Ru, Si, Sb, Nb or Te.

14. The sodium-ion battery according to claim 1, wherein the M element is one or more selected from Al, Mg, Zn, Co, Ca, B, Sn or Ti.

15. The sodium-ion battery according to claim 1, wherein a Dv50 of the positive electrode active substance is 15 μm-20 μm.

16. The sodium-ion battery according to claim 1, wherein a press density of the positive electrode plate is 4.0 g/cm³-4.4 g/cm³.

17. The sodium-ion battery according to claim 1, wherein the electrolyte solution comprises a sodium salt;
the sodium salt is one or more selected from sodium hexafluorophosphate, sodium tetrafluoroborate, sodium perchlorate, sodium hexafluoroarsenate, sodium hexafluoroantimonate, sodium difluorophosphate, sodium 4,5-dicyano-2-trifluoromethy limidazole, sodium bis(oxalato)borate, sodium bis(malonato)borate, sodium difluoro(oxalato)borate, sodium bis(difluoromalonato)borate, sodium (malonatooxalato)borate, sodium (difluoromalonatooxalato)borate, sodium tris(oxalato)phosphate, sodium tris(difluoromalonato)phosphate, sodium tetrafluoro(oxalato)phosphate, sodium difluorobis(oxalato)phosphate, sodium bis(fluorosulfonyl)imide, sodium bis(trifluoromethanesulfonyl)imide, sodium (fluorosulfonyl)(trifluoromethanesulfonyl)imide, sodium nitrate or sodium fluoride.

18. The sodium-ion battery according to claim 17, wherein a concentration of the sodium salt in the electrolyte solution is 0.2 mol/L-2.0 mol/L.

19. The sodium-ion battery according to claim 1, wherein an active material in the negative electrode plate comprises at least one of natural graphite, artificial graphite, mesocarbon microbead, hard carbon, soft carbon, Sn, SnO, SnO₂, Sb, Sb₂O₃, Bi, Bi₂O₃ or TiO₂.

20. The sodium-ion battery according to claim 1, wherein a charge cut-off voltage of the sodium-ion battery is less than 4.1 V.
